(19) United States
(12) Patent Application Publication
(10) Pub. No.: US 2017/0178250 A1
(43) Pub. Date: Jun. 22, 2017

(54) Prayer reminder system and method

(71) Applicants: Joselyn Haight, Fort Myers, FL (US); Daniel Haight, Fort Myers, FL (US)

(72) Inventors: Joselyn Haight, Fort Myers, FL (US); Daniel Haight, Fort Myers, FL (US)

(21) Appl. No.: 14/971,945

(22) Filed: Dec. 16, 2015

(51) Int. Cl. G06Q 50/00; G06Q 30/02; G06Q 30/06; G06Q 10/10

(52) U.S. Cl. CPC G06Q 50/01; G06Q 10/1097; G06Q 30/0282; G06Q 30/0633

(57) ABSTRACT

A prayer reminder system having a plurality of steps beginning with system initiation. Then a user navigates the system by selecting one or more options, wherein the options are available to the user on a dashboard. The user schedules seven prayer times per day, wherein a prayer reminder is provided to the user. Prayer times are automatically or manually established. The user receives bible verses meant to inspire the user. The user also creates a prayer request that is sent to friends and groups. For example, the data may be bible verses, inspirational text, and prayer requests. The user also manages friends and one or more groups. The user communicates with friends and religious organizations. Communications are exchanged between users based upon the user's affiliation with one or more friends and one or more group. The religious organizations may communicate with the users.

### BACKGROUND OF THE INVENTION

1. Field of Invention

The present invention relates to the field of prayer and in particular, systems that remind and encourage prayer.

2. Description of Related Art

The Bible, and religious texts generally, promote regular prayer and reflection for individuals. Regular reflection on faith and God enables individuals to become more in touch with their faith and beliefs, and deepen their understanding of God. However, in today's busy schedules, it is difficult to remember to pray and reflect on God a plurality of times every day.

In the Bible in particular, in Psalm 119:164 the text reads “7 times a day will I praise you”. This is viewed as an optimal number of times per day for reflection to permit deepening of faith.

There is therefore a need in the art for a system and method that facilitates users' prayer over a number of times every day, and provides sources of inspiration for the user to focus their prayer and deepen their understanding of God and their religion.

### SUMMARY OF THE INVENTION

In an embodiment, a prayer reminder system having a plurality of steps beginning with initiating the system. Then a user navigates the system by selecting one or more options, wherein the options are available to the user on a dashboard. The user schedules seven prayer times per day, wherein a prayer reminder is provided to the user. In an alternative embodiment, the prayer times are automatically established. The user receives one or more bible verses. The bible verses inspire the user. The user also creates a prayer request and retrieves data. For example, the data may be bible verses, inspirational text, and prayer requests. The user also manages one or more friends and one or more groups. The user communicates with one or more friends and one or more religious organizations. Communications are exchanged between users based upon the user's affiliation with one or more friends and one or more group, wherein the prayer request is sent to the one or more friends. The religious organizations may communicate with the users.

In an embodiment, a profile is created or fabricated. The user submits identifying information such as their name, location, religious affiliations, preferences, and other optional identifying information. The information is used to classify the user for receiving bible verses, product suggestions, and friend or group suggestions.

In an embodiment, managing one or more groups involves the user joining an existing group or establishing a new group.

In an embodiment, a user manages one or more friends. For example, a user manages friends by adding one or more friends, deleting one or more friends, and communicating with one or more friends

In an embodiment, retrieving data involves sending bible verses and receiving bible verses using a mobile device.

In an embodiment, retrieving data involves unsolicited presentation of inspirational communication.

In an embodiment, creating a prayer request involves the user determining the context of the prayer request, inputting the prayer request into the system, and approving publication of the prayer request.

In an embodiment, the user is able to search a physical memory storage device for bible verses.

In an embodiment, the user is presented with products for their review and purchase. wherein the products are presented to the user based upon the information.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the system, according to an embodiment of the present invention.

### DETAILED DESCRIPTION OF PREFERRED EMBODIMENTS

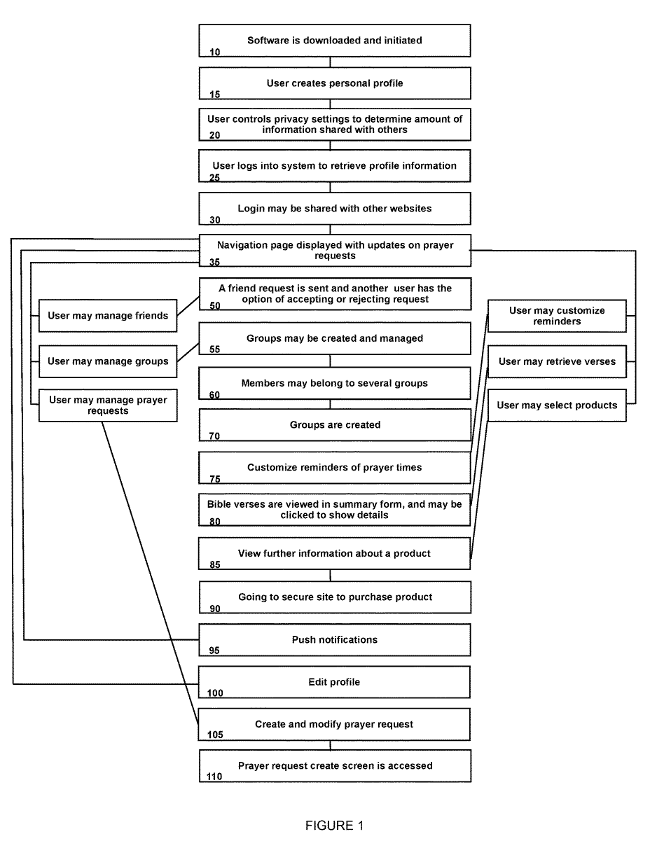

Preferred embodiments of the present invention and their advantages may be understood by referring to FIG. 1, wherein like reference numerals refer to like elements.

In one embodiment, the system is a software application that resides on a mobile device. In another embodiment, the system is network connected, on a website or web app for example, to enable convenient use by users.

In describing the user interface to the system, and with reference to FIG. 1, at step 10 once the software downloads or is initiated for the first time, at step 15 a user has an opportunity to create a personal profile that includes personal information and a picture. The profile may have fields such as photo, user name, first and last names, email address, phone number, password, address, gender and acceptance of terms and conditions. In step 20 the user controls privacy settings to determine how much personal information is shared with other users, wherein different privacy settings may be used for different groups (friends, acquaintances, etc.). On subsequent visits, the user simply logs into the system at step 25 to retrieve the profile information. At step 30, login may also be shared with other websites, such as Facebook, and in one embodiment, the login page has a username/email field, a password field, a login button (or “next” button) and a signup button, for users that do not have a login yet. If the login fails, an error message is displayed.

In step 20 the registration page has form fields for profile picture, user name, full name, email address, mobile phone number, and password. Optional fields may include city, state, address, date of birth, gender, and a checkbox for accepting terms and conditions, with a link to that document. Once the form is filled for registration, the user may login or use a Facebook account, and may validate, and provide error messages if the login information is incorrect.

When the user has created a profile or been logged in, at step 35 the user is provided a navigation page (“My Wall”) with a navigation menu. The navigation page displays and provides an update on the comments and prayer requests received by the user or that the user is participating in. The most recent may be displayed on the page or an icon may appear so that the user may click and move into that sub-menu. In step 40 the navigation page may provide a “slide in” menu which slides partially over the page from an edge of the screen and provides other navigation options, such as direct links back to the navigation page, links to friends or groups lists, the user's profile, and daily bible verses as well as featured product offers.

In step 40 the user may i) invite and manage friends, ii) create and manage groups to share personal information or prayer requests, iii) retrieve daily inspiration such as Bible verses, iv) customize the plurality of daily reminders as to time and notification, v) customize daily delivery of verses, vi) view or purchase featured products, vii) change the personal profile, and viii) create and manage prayer requests.

If the user chooses to invite or edit friends, at step 45 the user may group friends, invite friends they know or do not know through email or other notifications. Friends are joined to share personal information, the share and participate in prayer requests, and to create a sense of community. The user may browse the profiles of other users, and add a friend where the user is interested in connecting with the other user. For each user, an icon indicates that the user and the other user are already friends, another icon sends a friend request to the other user, and another icon indicates that the request has been sent to the user and is awaiting a response. A further icon lets the user ignore a request from the other user, or unfriend the other user. The user may also scroll through friends by the prayer requests of those friends or groups. In step 50 a friend request is sent and the other user has the option of accepting or rejecting the request. Once authorized to view the full profile page, the other user's profile page also provides select information about them, including comments they have made on other prayer requests. Groups of friends may establish a community by shared interests and intra-group communication.

If a user chooses to create and manage groups, in step 55 groups may be created, and friends invited to join. Group management enables churches and religious organizations to communicate directly with groups, wherein a single comment may address a number of group members. In step 60 members may belong to multiple groups at the same time, such that they receive messages from each of the groups. In step 55 a group may also be created on the create new group screen, which has form fields for a photo associated with the group, a group name, a description of the group, and adding users to the group, or inviting one or more users, wherein a user may accept or reject the invitation. The group creator may edit the group profile, or may appoint others to manage the group. The group can post individual prayer needs and send them instantaneously to the members of the group, and the group has its own wall to show the activity of the group.

In retrieving daily inspiration such as Bible verses, in step 70 the verses may be pre-selected by a moderator such that all members receive the same verse, or groups may receive difference verses depending on their focus. The title or first line of the verse may be shown, and if the user clicks on the title, the entire verse, in a scrollable format, is shown. In a preferred embodiment, the system provides a single Bible verse per a day, chosen by a moderator who selects the verse through the back-end. The system may track comments to verses in informing the system as to suggestions to the moderator for follow-up verses. If the system is off-line, a default Bible verse may be shown to users.

In step 75 users may customize their reminders of prayer times, according to i) actual time for the notification, ii) type of notification, and iii) subject of the prayer. The users may specify any time, day or night, and the bible verse delivery can be scheduled to be provided at the same time or a different time. There are 3 types of notifications: 1) a push notification in the form of a chime, 2) a text message that displays on the user's main screen, and 3) a note in the iPhone's reminder App. In a preferred embodiment, there are seven prayer times each day. The reminders are stored in a calendar wherein the user receives a notification reminder at the appropriate time, such as a pop-up on a mobile device of computer screen. Only the user may control his or her notification schedule, the groups cannot set up a notification schedule.

In step 80 the Bible verses may be viewed in a summary form, with references such as the book, chapter and verse, or by first line, for example. When the user clicks on the reference or the sample first line, the words are expanded to provide the full verse reading. Tapping again on the verse collapses it into the reference or the first line.

In step 85 the user may also view further information about a particular product or service that may be recommended through the system, and if the user likes, may purchase the product or service through the system. The product may be recommended as product of the day, or of the month, for example, and the subject matter of the product may relate to the Bible verse that is being provided to the user, or the current challenges input by the user. Products offered will be faith based music on iTunes, CD, or faith based reading materials such as books, or eBooks. In an embodiment, in step 90 clicking on the product brings the user to a secure site wherein the user may purchase the product or service. Purchase history may inform the subject matter of Bible verses that are delivered. In an embodiment, the products are listed with the price amount. In step 95 push notification may be used to notify of a new product addition, and by tapping the notification, the user may be sent to the details screen for the product, which sets out specifications and enables a purchase directly by the user. The system also sends out push notifications for friend requests, prayer postings, on a group or friend's wall, and the appearance of a new Bible verse.

In step 100 the edit profile feature enables the user to edit the profile, including email address or other contact information, name and interests, and photo. The security settings may also be updated, so that the users may determine who may view their profile, and how much information may be viewed by friends, groups or other users.

Once the user profile is created and the user adds other users to his or her list, in step 105 prayer requests may be issued by a user and sent to one or more friends and groups the user is part of. The prayer request has fields for title, description and select post options, such as selecting friends (using a toggle for each) or groups (using a toggle for each). Groups or friends to receive the prayer request may be selected individually to receive prayer requests. When the group or friends complete the prayer request at step 110, they may submit a notification to that effect. The prayer requests may be sent to the community as a whole, or to individual users.

In order to create the prayer request, at step 110 the prayer request create screen is used. A title, description and post options (public or private, and to one or more individuals and/or groups. Once the form is filled, the user selected either post, wherein the details are validated or cancel, wherein the information is cancelled. If there is an error during validation, a notification will be sent to the user indicating an invalid title or description.

In step 105 groups may also create prayer requests using the group prayer request create screen. A title and description are required, and the user can post the form or cancel the details entered into the form.

In step 125 users may comment others' prayer requests and their own, in response to another comment. Search functionality permits searching of friends, groups or prayer subjects. Groups or subgroups may be shown in the search. User may also accept or ignore other users' prayer requests.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A reminder system comprising the steps of:
a. initiating the system;
b. navigating the system by selecting one or more options, wherein the one or more options are available to a user on a dashboard;
c. scheduling seven prayer times per day, wherein a prayer reminder is provided to the user;
d. receiving one or more bible verses configured to inspire the user;
e. creating a prayer request;
f. retrieving data, wherein the data is selected from the group consisting of bible verses, inspirational text, and prayer requests;
g. managing one or more friends;
h. managing one or more groups; and
i. communicating with one or more friends and one or more religious organizations; wherein communications are exchanged between users based upon the user's affiliation with one or more friends and one or more groups,
wherein the prayer request is sent to the one or more friends.

2. The system of claim 1, further comprising the step of fabricating a profile, wherein the user submits identifying information, and wherein the information is configured to classify the user for receiving bible verses.

3. The system of claim 1, wherein the step of managing one or more groups comprises the user joining an existing group or establishing a new group.

4. The system of claim 1, wherein the step of managing one or more friends further comprises the steps of:
a. adding one or more friends;
b. deleting one or more friends; and
c. communicating with one or more friends

5. The system of claim 1, wherein the step of retrieving data further comprises sending bible verses and receiving bible verses using a mobile device.

6. The system of claim 1, wherein the step of retrieving data further comprises unsolicited presentation of inspirational communication.

7. The system of claim 1, wherein the step of creating a prayer request comprises the steps of:
a. determining the context of the prayer request;
b. inputting the prayer request into the system; and
c. approving publication of the prayer request,
wherein the user determines the context of the prayer request, wherein the user inputs the prayer request, and wherein the user approves the publication of the prayer request.

8. The system of claim 1, further comprising the step of searching physical memory storage for bible verses.

9. The system of claim 2, further comprising the steps of:
a. presenting products to the user;
b. reviewing the products; and
c. purchasing products,
wherein the products are presented to the user based upon the information, wherein the user reviews the products, and wherein the user purchases the products.
